(19) United States
(12) Patent Application Publication
(10) Pub. No.: US 2003/0180455 A1
(43) Pub. Date: Sep. 25, 2003

(54) Method for coating powder

(75) Inventors: Toshio Maetani, Chiba-Shi (JP); Naomichi Nakamura, Chiba-Shi (JP); Masaki Ueta, Chiba-Shi (JP); Shingo Saito, Chiba-Shi (JP)

Correspondence Address: IP DEPARTMENT OF PIPER RUDNICK LLP, 3400 TWO LOGAN SQUARE, 18TH AND ARCH STREETS, PHILADELPHIA, PA, 19103, US

(73) Assignee: KAWASAKI STEEL CORPORATION, Chuo-Ku (JP)

(21) Appl. No.: 10/391,244

(22) Filed: Mar. 18, 2003

(30) Foreign Application Priority Data
Mar. 19, 2002 (JP) 2002-076445

(51) Int. Cl. B05D 7/00; B05D 1/02

(52) U.S. Cl. 427/213; 427/421

(57) ABSTRACT

The invention provides a coating method for forming a uniform coating layer on the entirety of powder by using simple means. The method has the steps of supplying the powder into a container; rotating a stirring blade so that a rotation speed of an end portion thereof is about 1.5 m/sec or more while blowing a fluidizing gas into the powder at a velocity of about 3.0 m/sec or more from a position above the powder for stirring and fluidizing, the stirring blade being disposed at a bottom portion of the container; spraying a coating fluid onto the powder from a position thereabove; and drying the coating fluid to form a coating layer.

### BACKGROUND

1. Field of the Invention

This invention relates to coating methods for coating powders and, more particularly, relates to a method for coating a powder, which comprises spraying a fluid (coating fluid) containing a material, which is dissolved or dispersed in the fluid (a solvent or liquid media) and becomes a primary component of a coating layer, onto the powder and, simultaneously and/or subsequently, drying the coating fluid for coating the powder with the material. Hereinafter, the term “coating solution” is sometimes used for coating fluid, even if it is not a solvent in a strict sense, such as an emulsion.

2. Description of the Related Art

A powder metallurgy technique can manufacture products having a complicated and near-net shape with high dimensional accuracy and, in addition, can significantly reduce cutting and polishing costs. Accordingly, a great number of powder metallurgy products have been widely used for automobile components, electronic components, and the like.

Powders used as raw materials are properly selected in consideration of applications of the components mentioned above or the properties required therefor. In recent years, powders coated with various materials have also been studied to further improve the properties of the products.

As a method for forming a coating layer on the surface of a powder, a method is generally used which comprises the steps of spraying a coating solution containing a material, which becomes a primary component of a coating layer to be formed, onto a powder, and then drying the coating solution thus coated. FIG. 3 is a cross-sectional view schematically showing an example of a traditional apparatus used when a coating layer is formed by a method for spraying a coating solution onto a powder. As shown in FIG. 3, a powder 2 is received in a container 1 and then stirred by rotating a stirring blade 3 about a rotation shaft 7, the stirring blade 3 being provided at the bottom portion of the container 1. The arrow a shown in FIG. 3 indicates the rotation of the rotation shaft 7, and the arrow b indicates the flow of the powder 2 by the stirring.

Above the powder 2, a two-fluid nozzle 8 for discharging two types of fluids is provided. By supplying a spraying gas 4 and a coating solution 5 to the two-fluid nozzle 8, the coating solution 5 is sprayed onto the powder 2. Since a material, which becomes a primary component of a coating layer, is dissolved or dispersed in the coating solution 5, when the coating solution 5 is dried while being sprayed onto the powder 2, the coating layer is formed on the surface of the powder 2. For example, in Japanese Unexamined Patent Application Publication No. 2000-34502, a method similar to that described above is used when a powdered magnetic alloy is coated with a film containing a fluorine compound.

However, when the apparatus shown in FIG. 3 is used, since the flow (indicated by the arrow b) of the powder 2 in the container 1 is generated only by rotation of the stirring blade 3, it has been difficult for the coating solution 5, which is sprayed from a position above the powder 2, to uniformly adhere all over the particles thereof.

Accordingly, as an improvement of the method described above, a method has been studied which uses an apparatus such as a fluidized bed coater with rotating disc shown in FIG. 4.11.5 in “Funtai Kogaku Binran (Handbook of Powder Technology)” (second edition, edited by Soc. of Powder Technology, Japan, published by Nikkann Kogyo Shimbun Ltd.), p. 375. That is, as shown in FIG. 4, by using an apparatus in which the coating solution 5 is sprayed onto the powder 2 while a fluidizing gas 6 is blown into the container 1 from the bottom portion thereof, the powder 2 in the container 1 is coated with a uniform coating layer. The arrow c in FIG. 4 indicates the state of agitation in which the powder 2 is agitated by the fluidizing gas 6 blown into the container 1.

That is, as the flow of the powder 2 in this apparatus, by the fluidizing gas 6 blown into the container 1 in addition to the stirring (shown by the arrow b) by the rotation of the stirring blade 3, the agitation of the powder 2 is generated (shown by the arrow c). When the powder 2 in the state of agitation is sprayed with the coating solution 5, uniform coating layers are formed all over the particles of the powder 2.

However, when the apparatus shown in FIG. 4 is used, the structure of the entire apparatus becomes complicated and, as a result, maintenance of the facilities has to be increased.

It would therefore be advantageous to solve the problems described above, and provide a method for forming a substantially uniform coating layer over substantially the entirety of a powder by using simple means.

### SUMMARY OF THE INVENTION

We intensively investigated the influence of the rotation speed of a stirring blade and the velocity of a fluidizing gas on the stirring and agitation of a powder by blowing a fluidizing gas from a position above the powder while rotating the stirring blade provided at a bottom portion of a container in which the powder is received. As a result, we discovered that when the rotation speed of an end portion of the stirring blade and the velocity (that is, the velocity at the position at which the powder and the fluidizing gas are brought into contact to each other) of the fluidizing gas jetted into the powder are each controlled in a predetermined range, a uniform coating layer can be formed over the entire powder. This invention was made based on the discovery described above.

A method for coating a powder, according to aspects of the invention, comprises the steps of: supplying a powder into a container; fluidizing the powder by stirring the powder by rotating a stirring blade so that the rotation speed of an end portion thereof is approximately 1.5 m/sec or more while blowing a fluidizing gas into at least a portion of the powder, at a velocity of approximately 3.0 m/sec or more from a position above the powder, the stirring blade being disposed at a lower portion of the container; spraying a coating solution onto the powder from a position thereabove; and drying the coating solution preferably parallel with spraying, to form a coating layer.

In the embodiment of the invention described above, the end portion of the stirring blade is preferably rotated at a rotation speed of about 1.5 to about 30 m/sec, and the fluidizing gas is preferably blown into the powder at a velocity of about 3.0 to about 500 m/sec.

### BRIEF DESCRIPTION OF THE DRAWINGS

FIG. 1 is a cross-sectional view schematically showing an example of an apparatus to which the invention is applied;

FIG. 2 is a cross-sectional view schematically showing another example of an apparatus to which the invention is applied;

FIG. 3 is a cross-sectional view schematically showing an example of a traditional apparatus; and

FIG. 4 is a cross-sectional view schematically showing another example of a traditional apparatus.

### DETAILED DESCRIPTION

Powders to be coated by methods of the invention are not specifically limited. However, a powder having an average particle diameter of approximately 10 to 150 μm and a bulk density of approximately 1.0 to 4.5 g/cm³ is particularly preferable. As examples, there may be mentioned an atomized iron powder, a reduced iron powder, an iron-based alloy steel powder, a stainless steel powder, a nonferrous metal powder such as a aluminum or copper powder, nonferrous alloy steel powder, or an inorganic compound powder such as ceramic or glass.

In addition, the composition of the coating layer is not specifically limited as long as a coating fluid/solution is used for application to the powder. In this embodiment, a material for forming the coating layer is dissolved or dispersed (including a suspended state in the form of emulsion, suspension, or the like) in a liquid such as water or an organic solvent, thereby forming a coating solution. Next, the water or organic solvent described above is evaporated in a drying step. The organic solvent preferably has high volatility.

As an example of coating a powder, when a soft magnet powder such as an iron powder or a Sendust powder is used as a powder, and a solution containing an epoxy resin, a phenol resin, or the like dissolved in an organic solvent such as MEK (methyl ethyl ketone), toluene, or the like is used as a coating solution, a resin layer having high insulating properties can be formed on the surface of each particle of the powder. The powder as described above can be used as a raw material for forming low-loss core materials.

As a raw material for forming the core materials, in addition to that described above, when a solution containing chromic acid, phosphoric acid, oxalic acid, acetic acid, formic acid, or a salt of the acid mentioned above containing a metal element such as Mg, B, Ca, Al, or the like dissolved in water or an organic solvent such as ethanol is used as a coating solution, according to aspects of the invention, an insulating layer can be formed on the surface of a soft magnet powder such as an iron powder.

In addition, when a powdered raw material for forming a sintered product, such as an iron powder or a stainless steel powder, is used as a powder, and a lubricant, such as a metallic soap (for example, zinc stearate or lithium stearate) or a fatty acid amide (for example, stearamide), which is emulsified beforehand, is dispersed in a liquid media such as water as a coating solution, the lubricant is substantially uniformly applied onto the surfaces of particles of the powder and, as a result, the effect of suppressing friction in the metal molding step can be significantly improved.

Of course, the applications of the invention are not limited to those described above.

The concentration of a material in a coating solution (including liquid media) for forming a coating layer is preferably in the range of from approximately 0.5 to 20 wt %.

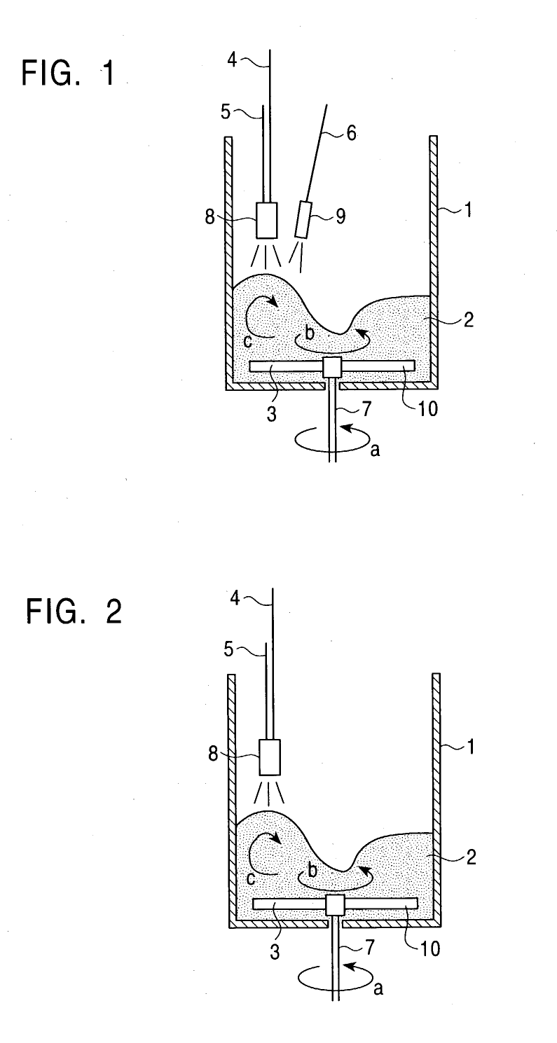

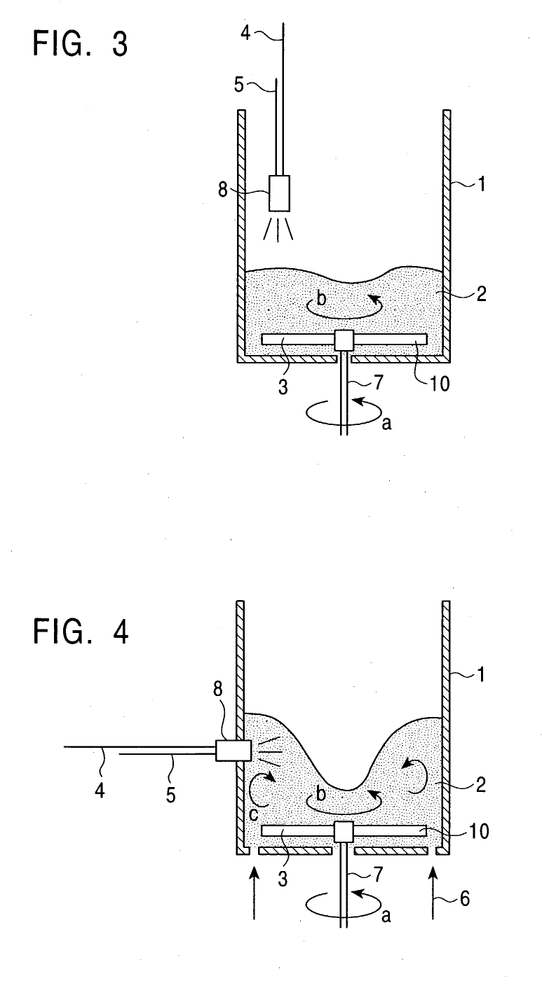

Hereinafter, the method of an aspect of the invention will be described in detail. FIG. 1 is a cross-sectional view schematically showing an example of an apparatus to which the invention is applied. As shown in FIG. 1, a powder 2 is contained in a container 1 and then stirred by rotating a stirring blade 3 about a rotation shaft 7, the stirring blade 3 being disposed in the vicinity of a bottom portion of the container 1. The arrow a in FIG. 1 indicates the rotation of the rotation shaft 7, and the arrow b indicates the flow of the powder 2 by stirring.

In the case described above, it is preferable that the diameter (length) of the stirring blade be set to approximately 100 to 2,000 mm, and that the inside diameter (when the cross-section of the bottom is not circular, the diameter of the inscribed circle) of the container be set to approximately 1.0 to 1.5 times that of the stirring blade. The container preferably has an approximately cylindrical shape. Concerning the amount of the powder charged in the container, the thickness (height of the charged powder) of the powder layer is preferably set to approximately one half of the diameter of the stirring blade or less.

We investigated the influence of the rotation of the stirring blade 3 on the stirring of the powder 2. That is, an atomized pure iron powder (KIP™-304AS, manufactured by Kawasaki Steel Corporation) was supplied into the container 1 as the powder 2, and after the powder 2 was allowed to stand still without using a spraying gas 4 or a fluidizing gas 6, the stirring blade 3 was rotated for 30 seconds. The amount of the powder 2 supplied into the container 1 was set to 2, 20, and 200 kg. A dye in an amount of 1 wt % of the amount of the powder was added onto the surface of the powder layer from one predetermined position before the rotation of the stirring blade 3, so as to perform a visual inspection of the mixed state of the powder 2 by variously changing the rotation number of the stirring blade 3. In each of the cases described above, a container in an approximately circular shape having a diameter of approximately 1.1 times that of the stirring blade was used as the container 1.

The results are shown in Table 1.

TABLE 1

| | Stirring Blade | | | |
|---|---|---|---|---|
| Amount | | | Rotation | Powder's |
| Of | | | Speed Of | State |
| Powder | Radius | Rotation Number | End Portion | Of |
| (Kg) | (m) | (Rotations/min) | (m/sec) | Mixture |
| 2 | 0.057 | 100 | 0.6 | Nonuniform |
| | | 200 | 1.2 | |
| | | 250 | 1.5 | Uniform |
| | | 500 | 3.0 | |
| | | 1000 | 6.0 | |
| 20 | 0.140 | 100 | 1.5 | |
| | | 200 | 2.9 | |
| | | 250 | 3.7 | |
| | | 500 | 7.3 | |
| | | 1000 | 14.7 | |
| 200 | 0.280 | 100 | 2.9 | |
| | | 200 | 5.9 | |
| | | 250 | 7.3 | |
| | | 500 | 14.7 | |
| | | 1000 | 29.3 | |

As can be seen in Table 1, when the rotation speed of an end portion 10 of the stirring blade 3 is 1.5 m/sec or more, it is confirmed that the powder 2 is sufficiently stirred in the container 1 and put into a uniformly mixed state. That is, in other words, the rotation speed of the end portion 10 of the stirring blade 3 must be set to about 1.5 m/sec or more. However, it is not preferable that the rotation speed exceed about 30 m/sec, since, depending on the strength and toughness of particles of the powder, the particles may be deformed or decomposed by shear stress in some cases. Consequently, the rotation speed of the end portion 10 of the stirring blade 3 is preferably in the range of from about 1.5 to about 30 m/sec.

As shown in FIG. 1, a two-fluid nozzle 8 and a fluidizing gas jet nozzle 9 are provided above the powder. This two-fluid nozzle 8 sprays the coating solution 5 together with the spraying gas 4 onto the powder 2. Since a material that becomes a primary component in a coating layer is dissolved or dispersed in the coating solution 5, when the coating solution 5 is sprayed onto the powder 2 and is dried, the coating layer is formed on the surface of the powder 2. The spray amount of the coating solution 5 is preferably in the range of from approximately 1 to 100 mg/s with respect to 1 kg of the powder.

In addition, the fluidizing gas jet nozzle 9 blows the fluidizing gas 6 into the powder 2, thereby generating the agitation indicated by the arrow c of the powder 2. In this case, the fluidizing gas 6 serves as a fluidizing gas.

As the fluidizing gas 6 and the spraying gas 4, common air may be used. However, depending on applications, an inert gas such as a nitrogen gas may also be used. In addition, these gases are usually at room temperature. However, in consideration of applications, the temperature of the fluidizing gas may be adjusted to suit the particular circumstances.

In addition, we investigated the influence of the injection of the fluidizing gas 6 on the flow of the powder 2. That is, the same atomized pure iron powder as that was used in the previous experiment was supplied into the container 1 (horizontal cross-section was an approximately circular form having a diameter of approximately 180 mm) as the powder 2. After the powder 2 was allowed to stand still without using the stirring blade 3, the fluidizing gas jet nozzle 9 was fixed at a position in contact with the upper surface of the powder 2 and then air was blown at room temperature as the fluidizing gas 6. That is, the velocity of the fluidizing gas 6 was a velocity at a position at which the fluidizing gas 6 was brought into contact with the powder 2 (that is, the velocity of the fluidizing gas 6 when blown into the powder 2). As described above, by variously changing the area (1.04, 13.9, and 55.0 mm²) of the jet orifice of the fluidizing gas jet nozzle 9 and the flow volume of the fluidizing gas 6, visual inspection was performed whether the agitation of the powder 2 was generated. The results are shown in Table 2.

TABLE 2

| Fluidizing Gas | | | |
|---|---|---|---|
| Area Of | | Velocity Blown Into | |
| Jet Orifice | Flow Volume | Powder | |
| (mm²) | (N-liter/min) | (m/sec) | Agitation Of Powder |
| 1.04 | 1 | 16 | Yes |
| | 5 | 80 | |
| | 10 | 160 | |
| | 20 | 321 | |
| 13.9 | 1 | 1.2 | No |
| | 5 | 6.0 | Yes |
| | 10 | 12.0 | |
| | 20 | 24.0 | |
| | 40 | 48.0 | |
| 55.0 | 1 | 0.3 | No |
| | 5 | 1.5 | |
| | 10 | 3.0 | Yes |
| | 20 | 6.1 | |
| | 40 | 12.1 | |
| | 100 | 30.3 | |
| | 200 | 60.6 | |

As can be seen in Table 2, when the velocity of the fluidizing gas 6 jetted into the powder 2 is about 3.0 m/sec or more, the agitation of the powder 2 is confirmed. That is, the velocity of the fluidizing gas 6 must be set to about 3.0 m/sec or more. However, when the velocity exceeds about 500 m/sec, the load applied to a injection device by the fluidizing gas 6 is increased and, as a result, device defects may occur in some cases. Consequently, the velocity of the fluidizing gas 6 jetted into the powder 2 is preferably in the range of from about 3.0 to about 500 m/sec.

The stirring and agitation of the powder 2 are substantially simultaneously performed (hereinafter sometimes referred to as “stirring and fluidizing”) by the stirring blade 3 and fluidizing gas 6, and the coating solution 5 is sprayed from the two-fluid nozzle 8. Accordingly, the entire surfaces of particles of the powder 2 are coated with the coating solution 5 and, hence, uniform coating layers can be obtained.

By providing the two-fluid nozzle 8 and the fluidizing gas jet nozzle 9, as shown in FIG. 1, and by increasing the flow volumes of the spraying gas 4 supplied through the two-fluid nozzle 8 and the fluidizing gas 6, the agitation (indicated by the arrow c) of the powder 2 may be generated. In this case, the spraying gas 4 and the fluidizing gas 6 both serve as a fluidizing gas.

In addition, as shown in FIG. 2, the agitation (indicated by the arrow c) of the powder 2 may be generated by using only the two-fluid nozzle 8 without the fluidizing gas jet nozzle 9 and by increasing the flow volume of only the spraying gas 4 supplied through the two-fluid nozzle 8. In this case, only the spraying gas 4 functions as a fluidizing gas. The same reference numerals of the constituent elements in FIG. 1 designate the equivalent constituent elements in FIG. 2.

In this embodiment, the position at which the fluidizing gas 6 (and the spraying gas 4) is blown into the powder can be optionally determined. However, as shown in FIGS. 1 and 2, since the agitation can be efficiently generated, the fluidizing gas is preferably blown into the vicinity of the end portion of the stirring blade 3 (that is, an area at which the stirring is most vigorously performed by the stirring blade 3) from a position above the powder 2. In addition, the coating solution is preferably sprayed to the area at which the agitation is generated.

It is not necessary to provide pipes and an injecting device for the fluidizing gas 6 at the bottom portion of the container 1. In addition, since part of the powder 2 to be sprayed with the coating solution may only be agitated, the flow volume of the fluidizing gas 6 may be small. Accordingly, by this simple means, the coating solution 5 can be applied substantially uniformly to the entire powder 2, dried and, hence, a coating layer is formed on the surface of the powder 2.

Hereinafter, the drying step will be described. Since particles of the powder sprayed with the coating solution are brought into contact with gases flowing in the container while other particles are sprayed with the coating solution, drying also proceeds in the spraying step. However, in order to facilitate the drying, for example, there may be a method for feeding the spraying gas 4 and/or the fluidizing gas 6 following the heating thereof or a method for heating the container 1. By the process or the method described above, formation of the coating layer by evaporating a solvent of the coating solution can also be performed in the spraying step.

In addition, after the spraying step is complete, drying may be reliably performed by continuing the stirring as an additional drying step. In the latter case described above, the stirring performed by the fluidizing gas is preferably performed during drying. In addition, when the stirring is continued after the spraying is complete, the rotation number of the stirring blade may be increased or decreased whenever necessary. Of course, heating of the spraying gas 4 and/or the fluidizing gas 6 or heating of the container 1 may also be performed.

### EXAMPLES

Hereinafter, the invention will be described in more detail with reference to examples. However, the spirit and the scope of invention are not limited to the conditions described in the following examples.

### Example 1

In examples 1 to 5, 10, 11 and comparative examples 1 to 5 shown in Table 3, the apparatus shown in FIG. 2 was used, and an atomized pure iron powder (KIP™-304AS, an average particle diameter of 75 μm, an apparent density of 3.0 Mg/m³, manufactured by Kawasaki Steel Corporation) and a Sendust powder (primarily composed of Fe, Al, and Si, an average particle diameter of 53 μm, and apparent density of 2.24 Mg/m³) were used as the powder 2. In addition, as the coating solution 5, a phenol resin solution at a concentration of 20 wt % using acetone as a solvent and an epoxy resin solution at a concentration of 20 wt % using the same solvent as mentioned above were used.

The powder 2 in an amount of 20 kg was supplied into the container 1 and then sprayed with the coating solution 5 supplied from a position above the powder 2 for 900 seconds while being stirred and fluidized by variously changing the rotation speed of the end portion 10 of the stirring blade 3 and the velocity of the spraying gas 4 blown into the powder 2. Next, the spray of the coating solution 5 was stopped, and the rotation of the stirring blade 3 and the injection of the spraying gas 4 were continued for 300 seconds for drying, thereby forming a coating layer.

After the coating process described above, the powder 2 was recovered from the apparatus and then processed at 200° C. for 60 minutes for curing the resin contained in the coating layer.

In this example, the container 1 having an approximately circular shape in plan view (that is, an approximately cylindrical shape) 300 mm in diameter was used, and the diameter of the blade of the stirring blade 3 was set to 280 mm. In this example, as the spraying gas 4 that was also used as a fluidizing gas, air at room temperature was used. The spray amount of the coating solution on a time basis was set to 400 mg/s.

In examples 6 to 9 shown in Table 3, the apparatus shown in FIG. 1 was used, and the same atomized pure iron powder (KIP™-304AS) as those in example 1 or the like were also used as the powder 2. In addition, as the coating solution 5, a phenol resin solution at a concentration of 20 wt % using acetone as a solvent was used.

The powder 2 in an amount of 20 kg was received in the container 1 and sprayed with the coating solution 5 supplied from a position above the powder 2 for 900 seconds while being stirred and fluidized by variously changing the velocities of the spraying gas 4 and the fluidizing gas 6 blown into the powder 2 at a constant rotation speed (5.00 m/sec) of the end portion of the stirring blade 3. Next, the spray of the coating solution 5 and the spraying gas 4 was stopped, and the rotation of the stirring blade 3 and the jet of the fluidizing gas 6 were continued for 300 seconds for drying, thereby forming a coating layer. A nozzle similar to that in example 1 was used, and the fluidizing gas and the spraying gas at room temperature were used.

After the coating process described above, the powder 2 was recovered from the apparatus and then processed at 200° C. for 60 minutes for curing the resin contained in the coating layer.

A sample in a ring shape (an outer diameter of 38 mm, an inner diameter of 25 mm, and a thickness of 6.2 mm) was formed from the powder 2 having the coating layer thus obtained by pressure molding at a pressure of 980 MPa. Next, the resistivity (μΩ·m) of each sample was measured using a four-terminal method. The results are shown in Table 3. A higher resistivity indicates that the insulating properties of the powder 2 are superior, and that a uniform coating layer is obtained.

TABLE 3

| | | | Coating Method | | | |
|---|---|---|---|---|---|---|
| | | | Stirring | | | |
| | | | Blade | Spraying | Fluidizing | |
| | | | Rotation | Gas | Gas | |
| | | | Speed of End | Velocity | Velocity | Resistivity |
| | Powder | Coating Solution | Portion (m/sec) | (m/sec) | (m/sec) | (μΩ · m) |
| Example 1 | Iron Powder | Phenol Resin Solution | 1.53 | 6.5 | — | 3060 |
| Example 2 | Iron Powder | Phenol Resin Solution | 3.06 | 6.5 | — | 3560 |
| Example 3 | Iron Powder | Phenol Resin Solution | 19.5 | 6.5 | — | 4190 |
| Example 4 | Iron Powder | Phenol Resin Solution | 5.00 | 3.1 | — | 3170 |
| Example 5 | Iron Powder | Phenol Resin Solution | 5.00 | 18.0 | — | 4270 |
| Example 6 | Iron Powder | Phenol Resin Solution | 5.00 | 2.5 | 3.5 | 3110 |
| Example 7 | Iron Powder | Phenol Resin Solution | 5.00 | 3.2 | 3.5 | 3180 |
| Example 8 | Iron Powder | Phenol Resin Solution | 5.00 | 3.2 | 5.5 | 3850 |
| Example 9 | Iron Powder | Phenol Resin Solution | 5.00 | 3.2 | 20.3 | 4260 |
| Example 10 | Sendust Powder | Phenol Resin Solution | 5.00 | 18.0 | — | 21000 |
| Example 11 | Iron Powder | Epoxy Resin Solution | 5.00 | 18.0 | — | 4190 |
| Comparative Example 1 | Iron Powder | Phenol Resin Solution | — | 2.5 | — | 20 |
| Comparative Example 2 | Iron Powder | Phenol Resin Solution | 1.41 | 2.9 | — | 1720 |
| Comparative Example 3 | Iron Powder | Phenol Resin Solution | 1.41 | 6.5 | — | 2450 |
| Comparative Example 4 | Iron Powder | Phenol Resin Solution | 5.00 | 2.9 | — | 2310 |
| Comparative Example 5 | Sendust Powder | Phenol Resin Solution | 5.00 | 2.5 | — | 9080 |

Examples 1 to 11 are examples in which the rotation speed of the end portion of the stirring blade 3 and the velocity of the fluidizing gas (that is, the spraying gas 4 and/or the fluidizing gas 6) are within the ranges of aspects of the invention. Comparative example 1 is an example in which the stirring blade 3 is not rotated and the velocity of the spraying gas 4 is out of the range of the invention. Comparative example 2 is an example in which the rotation speed of the end portion of the stirring blade 3 and the velocity of the spraying gas 4 are out of the range of the invention. Comparative example 3 is an example in which the rotation speed of the end portion of the stirring blade 3 is out of the range of the invention. Comparative examples 4 and 5 are examples in which the velocity of the spraying gas 4 is out of the range of the invention.

The resistivities of the samples obtained in examples 1 to 9 in which iron powder was used as the powder 2 were 3,060 to 4,270 μΩ·m and, on the other hand, the resistivities of the samples obtained in comparative examples 1 to 4 in which the same iron powder as the above was used as the powder 2 were 20 to 2,450 μΩ·m. In addition, in example 10 and comparative example 5 in which a Sendust powder was used as the powder 2, the resistivity of the sample obtained in example 10 was approximately twice that obtained in comparative example 5. Accordingly, since the powder having the coating layer, which is formed by the coating method of the invention, has a higher resistivity, it is confirmed that a uniform coating layer is formed.

### Example 2

In examples 12 to 15 and comparative examples 6 to 8 shown in Table 4, the same atomized pure iron powder as that in example 1 or the like was used as the powder 2, and as the coating solution 5, an ethanol solution containing 10 wt % of phosphoric acid and an aqueous solution containing 10 wt % of aluminum primary phosphate were used. Under the conditions in which the spray amount of the spraying gas 4 and the spray time were set to 300 mg/s and 2,000 seconds, respectively, and in which the rest of the coating conditions were set to the same as those in example 1, an iron powder was produced which was composed of particles each having an insulating layer thereon. In the case in which the ethanol solution containing phosphoric acid was sprayed, the phosphoric acid in the solution reacted with the surface of the iron powder, thereby forming an insulating coating layer.

A sample in a ring shape (an outer diameter of 38 mm, an inner diameter of 25 mm, and a thickness of 6.2 mm) was from the powder 2 having the coating layer thus produced by the same method as in Example 1. The resistivity μΩ·m) of each sample was measured using a four-terminal method, and the results are shown in Table 4. A higher resistivity indicates that the insulating properties of the powder 2 are superior, and that a uniform coating layer is obtained.

TABLE 4

| | | | Coating Method | | | |
|---|---|---|---|---|---|---|
| | | | Stirring | | | |
| | | | Blade | Spraying | Fluidizing | |
| | | | Rotation | Gas | Gas | |
| | | | Speed of End | Velocity | Velocity | Resistivity |
| | Powder | Coating Solution | Portion (m/sec) | (m/sec) | (m/sec) | (μΩ · m) |
| Example 12 | Iron | Ethanol Solution Containing | 3.06 | 6.5 | — | 50 |
| | Powder | Phosphoric Acid | | | | |
| Example 13 | Iron | Ethanol Solution Containing | 5.00 | 3.1 | — | 60 |
| | Powder | Phosphoric Acid | | | | |
| Example 14 | Iron | Aqueous Solution Containing | 3.06 | 6.5 | — | 467 |
| | Powder | Aluminum Primary Phosphate | | | | |
| Example 15 | Iron | Aqueous Solution Containing | 5.00 | 3.1 | — | 473 |
| | Powder | Aluminum Primary Phosphate | | | | |
| Comparative | Iron | Ethanol Solution Containing | 1.20 | 6.5 | — | 14 |
| Example 6 | Powder | Phosphoric Acid | | | | |
| Comparative | Iron | Aqueous Solution Containing | 2.54 | 2.4 | — | 225 |
| Example 7 | Powder | Aluminum Primary Phosphate | | | | |
| Comparative | Iron | Ethanol Solution Containing | 2.54 | 2.4 | — | 12 |
| Example 8 | Powder | Phosphoric Acid | | | | |

Examples 12 to 15 are examples in which the rotation speed of the end portion of the stirring blade 3 and the velocity of the fluidizing gas (that is, the spraying gas 4 and/or the fluidizing gas 6) are within the ranges of the invention. Comparative example 6 is an example in which the rotation speed of the end portion of the stirring blade 3 is out of the range of the invention. Comparative examples 7 and 8 are examples in which the velocity of the spraying gas 4 is out of the range of the invention.

The resistivities of the samples obtained in examples 12 and 13 in which phosphoric acid was used for the coating solution were 50 to 60 μΩ·m and, on the other hand, the resistivities of the samples obtained in comparative examples 6 and 8 were 12 to 14 μΩ·m. In addition, the resistivities of the samples obtained in examples 14 and 15 in which aluminum primary phosphate was used for the coating solution were 467 to 473 μΩ·m and, on the other hand, the resistivity of the sample in comparative example 7 is 225 μΩ·m. Accordingly, since the powder having the coating layer, which is formed by the coating method of the invention, has a higher resistivity, it is confirmed that a uniform coating layer is formed.

A soft magnetic powder such as iron powder provided with a uniform insulating coating layer by aspects of the invention is preferably used as a raw material for manufacturing cores having a small loss (iron loss).

What is claimed is:

1. A method for coating powder, comprising:
supplying the powder into a container;
fluidizing at least a portion of the powder by rotating a stirring blade in a lower portion of the container so that a rotation speed of an end portion of the stirring blade is approximately 1.5 m/sec or more while blowing a fluidizing gas into at least a portion of the powder at a velocity of approximately 3.0 m/sec or more from a position above the powder;
spraying the powder with a coating fluid from a position above the powder; and
drying the coating fluid to form a substantially uniform coating layer on the powder.

2. The method for coating a powder, according to claim 1, wherein the end portion of the stirring blade is rotated at a rotation speed of approximately 1.5 to 30 m/sec, and wherein the fluidizing gas is blown into the powder at a velocity of approximately 3.0 to 500 m/sec.
